(19) United States
(12) Patent Application Publication
(10) Pub. No.: US 2013/0278760 A1
(43) Pub. Date: Oct. 24, 2013

(54) AUGMENTED REALITY PRODUCT DISPLAY

(71) Applicants: Brian R. Beams, Agoura Hills, CA (US); Paul E. Miller, Leona Valley, CA (US); Benito B. Gomez, Thousand Oaks, CA (US)

(72) Inventors: Brian R. Beams, Agoura Hills, CA (US); Paul E. Miller, Leona Valley, CA (US); Benito B. Gomez, Thousand Oaks, CA (US)

(73) Assignee: PHARMAVITE LLC, Northrdige, CA (US)

(21) Appl. No.: 13/452,288

(22) Filed: Apr. 20, 2012

(51) Int. Cl. H04N 7/18

(52) U.S. Cl. 348/143; 348/E07.085

(57) ABSTRACT

A product advertisement system that includes a set of products and an endcap product display in a store, pharmacy, supermarket or other retail establishment. A video camera integrated into the product display records a video of an area in front of the display. Using a video and a set of processing components, the product display detects the presence of a consumer in front of the display and identifies a product held by the consumer. Based on the detected product, the product display produces and outputs a video presentation that educates the consumer on the benefits and characteristics of the detected product. The presentation includes a live stream of the video showing the consumer standing in front of the product display with the product.

### BACKGROUND

As research into dietary supplements and vitamins expands, the number of products available to consumers is also on the rise. Although an increasing amount of choices is generally viewed favorably by consumers, this extensive number of options can often also be daunting and confusing. For example, B-Complex vitamins are provided in a number of different forms and formulas. Nature Made® produces several different varieties of B-Complex vitamins and supplements including Super B-Complex Liquid SoftGels, Stress B-Complex with Vitamin C and Zinc, B-Complex with C, Balanced B-100 Timed Release, Balanced B-50 Timed Released, and Super B-Complex. Although each of these products generally assists with cell-metabolism, each product also includes a number of differences and distinguishing characteristics.

Consumers often need to consult a nutritionist, dietitian, pharmacist, physician, or manual to determine the distinguishing characteristics of each product and what product is right for their personal needs. This is a laborious and often fruitless endeavor as store employees and medical professionals are frequently not versed in each product and do not have time to investigate for the consumer. Further, the amount of time and resources needed for a consumer to personally investigate and determine the differences and benefits of each product is typically prohibitive. This is especially true in a store or pharmacy setting where consumers are rushed and do not have access to vitamin and supplement manuals.

### BRIEF DESCRIPTION OF THE DRAWINGS

Embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one.

FIG. 1 shows a product advertisement system that includes a set of products and an endcap product display in a store, pharmacy, supermarket or other retail establishment.

FIG. 2 shows a component diagram of one embodiment of the endcap product display.

FIG. 3 shows a method for advertising one or more products held on the product display according to one embodiment.

FIG. 4 shows a frame of an augmented reality video presentation generated by a video production unit for directing a consumer to select and show a product to a video camera of the product display.

FIG. 5 shows a frame of an augmented reality video presentation generated by the video production unit for presenting educational materials on a detected product.

FIG. 6 shows a frame of an augmented reality video presentation generated by the video production unit for presenting options related to a detected product.

### DETAILED DESCRIPTION

Several embodiments are described with reference to the appended drawings are now explained. While numerous details are set forth, it is understood that some embodiments of the invention may be practiced without these details. In other instances, well-known circuits, structures, and techniques have not been shown in detail so as not to obscure the understanding of this description.

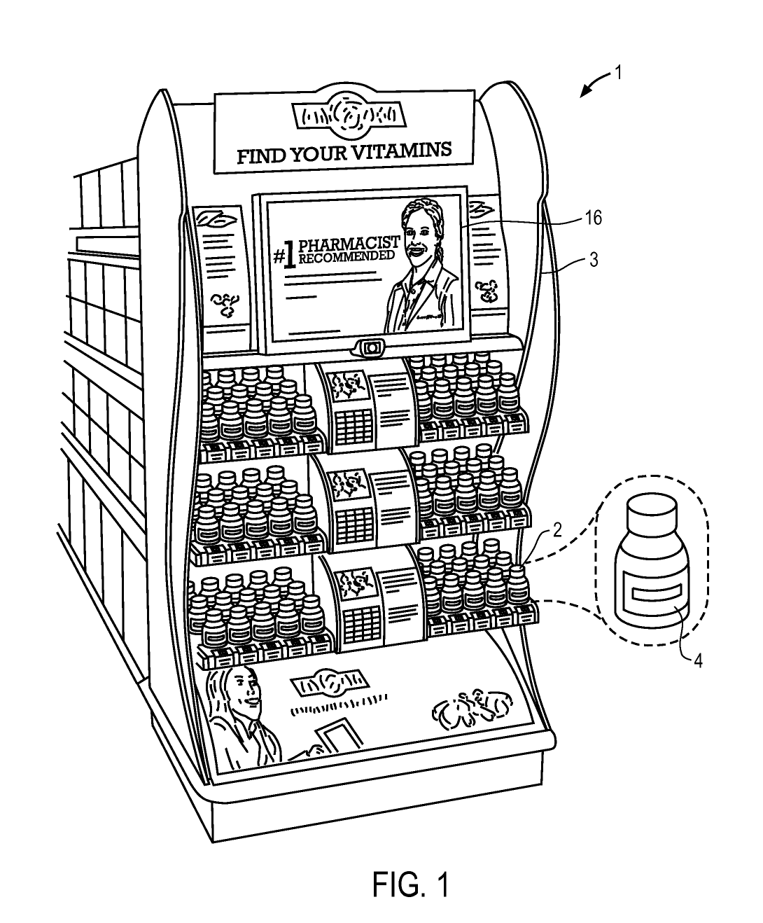

FIG. 1 shows product advertisement system 1 that includes products 2 and endcap product display 3 in a store, such as a pharmacy, supermarket or other retail establishment. Product advertisement system 1 provides an augmented reality presentation and advertisement for products 2. An augmented reality presentation is a presentation that incorporates both a live video stream, possibly with a consumer, and pre-recorded material. By delivering an augmented reality presentation about products 2, the product advertisement system 1 directly engages consumers and provides a more effective presentation/advertisement. Each of the elements of product advertisement system 1 will be described in detail below by way of example.

Products 2 are items for purchase in a retail establishment. Although often described herein as dietary supplements and vitamins, these are merely examples and products 2 may be any type of merchandise that may be contained in a product display in a store (e.g. a pharmacy or supermarket). Products 2 may be held or stored in a container (e.g. a bottle, carton, or crate) as they are exhibited on product display 3. Hereinafter, products 2 and their associated containers will be referred to collectively as products 2 for simplicity.

In one embodiment, products 2 are labeled for clear identification of products 2 by consumers. The magnified insert in FIG. 1 shows one of products 2 having label 4. Label 4 may be a piece of paper, polymer, cloth, metal, or other material capable of being affixed to one of products 2. In some embodiments, label 4 may be replaced or supplemented with other devices for identifying one of products 2 such as a digital identifier (e.g. a radio frequency identifier).

Label 4 includes one or more visible identifiers for identifying a product or product type to a consumer. In one embodiment, label 4 includes identifiers on separate sections for identifying multiple characteristics of the one of products 2 (e.g. the class of products 2, the specific type of products 2 within the class). For example, where a selected product are vitamins, label 4 may include a first section that identifies the selected product as a vitamin B class supplement and a second section that identifies the selected product as Super B-Complex Liquid SoftGels. In this embodiment, the different sections of label 4 may be read independently to identify products 2 within a class or a specific type, respectively.

In one embodiment, the one or more identifiers on label 4 are one or more of a barcode, a quick response code, a SPARQCode, and a contrast signature of label 4. Label 4 may include additional information in addition to the identifiers, including but not limited to a manufacturer name, manufacturer address, nutritional information and use restrictions, or warnings.

Products 2 are held and/or displayed on product display 3 using any known device for holding products 2. For example, products 2 may be suspended from hooks, rested on shelves, or held in bins on product display 3. Product display 3 calls attention to or advertises products 2 and in one embodiment educates consumers on the differences and benefits of respective products 2 in display 3 through audio/video presentations.

Product display 3 is described herein as being an endcap product display. An endcap display is a product display that is located at the end of aisle or at the beginning of an aisle. Although described as an endcap display, product display 3 may also be located in the middle of an aisle or anywhere else in a retail establishment.

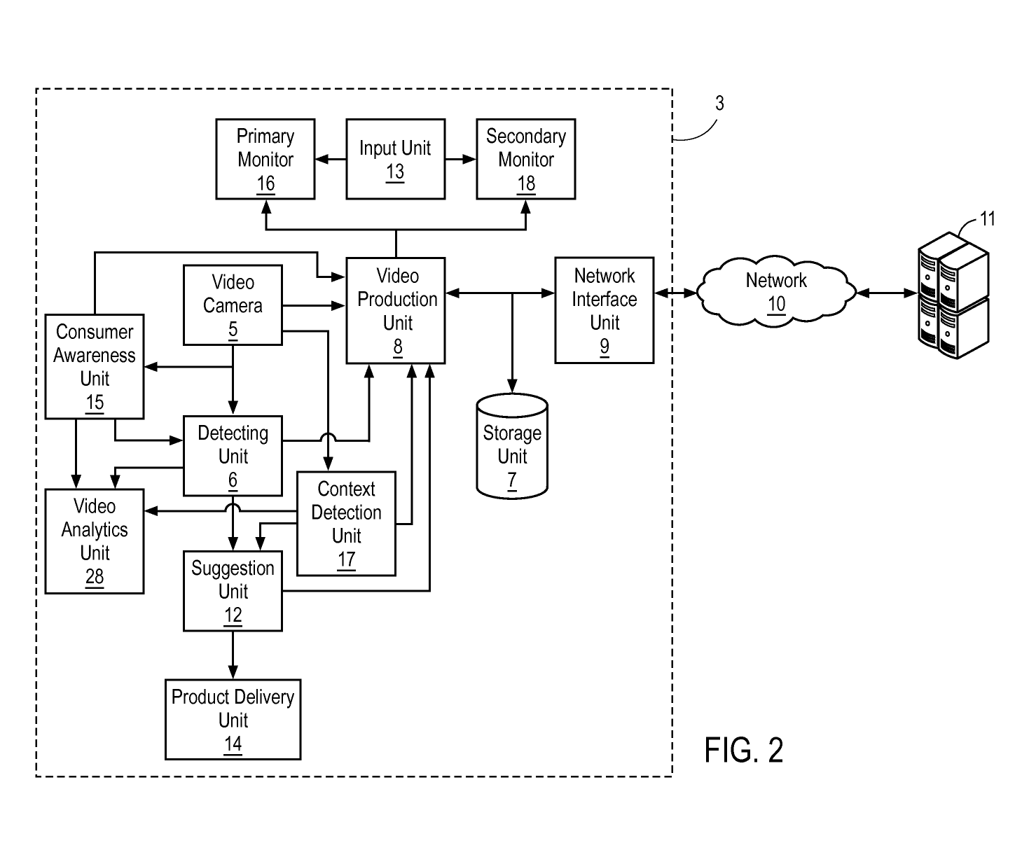

FIG. 2 shows a component diagram of one embodiment of endcap product display 3 where various components of product advertisement system 1 are contained and physically or logically connected as described below. Although not shown, product display 3 is connected to a power source to power one or more of the components. In one embodiment, the power source is an electrical outlet on a wall, floor, or other surface of the retail establishment in which product display 3 is located. In other embodiments, the power source may be one or more batteries integrated into product display 3.

Product display 3 includes video camera 5 contained therein that is used to capture a video in front of product display 3 and output a corresponding video stream. A video is a sequence of still images (frames) representing a scene in motion. The video and constituent images or frames may be encoded using any known algorithm or compression technique. Video camera 5 may include any type of sensor for selectively capturing two-dimensional or three-dimensional video, including a charge-coupled device (CCD) or a complementary metal-oxide-semiconductor (CMOS). Video camera 5 may include any set of digital or optical filters for de-noising, enhancing, or otherwise improving the video stream for processing. Video camera 5 may be visible to a consumer or may be hidden in the trim, border, or other area of product display 3. In one embodiment, video camera 5 pivots using a motorized support to track consumers as they walk in front of product display 3 using facial tracking algorithms.

In one embodiment, product display 3 includes more than one video camera 5. Multiple video cameras may be used to capture the same area in front of product display 3 from different angles or each video camera may be used to capture different areas around product display 3. For example, one video camera 5 may be aimed to capture the torso and head of consumers five to seven feet in height, while a second video camera 5 may be aimed to capture the torso and head of consumers three to five feet in height or in a wheelchair. The multiple video cameras independently produce video streams representing an area in front of product display 3. These video streams may be individually processed or collectively processed using the system and method described below. For purposes of simplicity, only one video stream will be used in the description below; however, multiple video streams from multiple video cameras may be used in a similar fashion.

A video stream from video camera 5 is output to detecting unit 6. This output may be a direct physical connection from video camera 5 to a computer defining or implementing detecting unit 6 or the video stream may be stored in shared memory, such as storage unit 7, and accessible by detecting unit 6.

Detecting unit 6 detects and identifies the presence of products 2 in the video stream. In one embodiment, detecting unit 6 first detects the presence of an object in the video stream that may be one of products 2 by continually analyzing frames or segments of frames in the video stream output from video camera 5. After the detection of a potential one of products 2, detecting unit 6 attempts to identify/classify the potential product (e.g. the type or class of the product) based on the frame or frames determined to contain the potential product. In one embodiment, identification is performed using a template based object identification algorithm. Under a template based approach, a set of templates corresponding to products 2 are predefined and stored in storage unit 7. The templates may be images or videos of products 2 or label 4 or generalized descriptors of products 2 or label 4 represented in data structures. For example, several images of label 4 or a data structure describing label 4 may be stored in storage unit 7. These images, videos, or descriptors are defined during a learning process that is performed prior to product display 3 being installed in a retail establishment or after new products are introduced to product display 3.

In one embodiment, a confidence level is assigned to a potential match with a template and corresponding to one of products 2. For example, a confidence level of 85 percent may be assigned to the product Super B-Complex Liquid SoftGels. This indicates that detecting unit 6 is 85 percent certain that a consumer is holding Super B-Complex Liquid SoftGels in a frame of the video stream. In one embodiment, if the assigned confidence level is greater than a predefined level, detecting unit 6 indicates that a match has been made and the consumer is holding the matched product (e.g. Super B-Complex Liquid SoftGels). Otherwise, detecting unit 6 continues to analyze frames of the video stream to detect and identify one of products 2. In one embodiment, if multiple matches with confidence levels above the predefined level are made by detecting unit 6, the product and template with the highest confidence level is selected.

Upon the detection and identification of a selected product with a confidence level above the predefined level, detection unit 6 transmits information about the selected product to video production unit 8. The transmission may be a textual description of the selected product (e.g. the product name); a numerical identifier of the selected product (e.g. a barcode number); a memory location in shared memory corresponding to the selected product; or any other descriptor.

Video production unit 8 constructs video presentations, interactive advertisements, and/or movies regarding the selected product. In one embodiment, video production unit 8 retrieves educational materials related to the selected product from storage unit 7. The educational materials may be videos, audio clips, or text that describes the benefits, characteristics, recommended usage, or similar details about the selected product. For example, the educational materials may be a video of a medical professional describing the health benefits of the selected product and the differences between the selected product and other similar products.

In one embodiment, video production unit 8 obtains the educational materials from storage unit 7. Storage unit 7 is a memory device located locally in product display 3 that stores files and data for use by components of product display 3. Storage unit 7 may be a set of hard disk drives (HDD), a set of solid-state drives (SSD), a set of optical disk drives (ODD), or a hybrid model incorporating multiple types of drives. Storage unit 7 is physically and/or logically connected to one or more components of product display 3, including video production unit 8, to allow the retrieval and sharing of data.

In one embodiment, product display 3 includes network interface unit 9 for connecting product display 3 to network 10. Network interface unit 9 may be capable of accessing one or more local or remote networks 10 using standard protocols to access remote devices/servers or be accessed by remote devices/servers. For example, network interface unit 9 may be capable of communicating with remote server 11 using one or more of TCP/IP, IEEE 802.X, GSM, CDMA, LTE, WiMAX, etc. In one embodiment, video production unit 8 may retrieve educational materials from remote server 11 through network interface unit 9 via network 10.

In one embodiment, video production unit 8 overlays these educational materials on a background of the live video stream from video camera 5 to produce an augmented reality presentation. The live video stream includes the consumer holding the selected product in the background and the educational materials are played in a partially transparent foreground. In other embodiments, the live video stream may be captioned in a segment of the video presentation. For example, the live video stream may be in a box in the top left corner of the presentation overlaid on the educational materials. This use of both a live video stream and prerecorded materials defines the augmented reality presentation. By including live video of the consumer in the video presentation to produce an augmented reality presentation, consumers are encouraged to view and be engaged with the presentation.

Although the video presentation constructed by video production unit 8 is triggered by the detection of one of products 2 in the video stream, the selected product does not need to remain visible in the video stream for the presentation to continue playing. Instead, after commencement of the presentation the consumer may put down the selected product or otherwise remove the selected product from the line of sight of video camera 5 and the video presentation will continue uninterrupted until the presentation is completed or the consumer walks away from product display 3.

In one embodiment, product display 3 includes suggestion unit 12 for determining options that may be presented to the consumer in the video presentation. The options may be more information about the selected product in addition to the educational materials already presented to the consumer or information on suggested products. The suggested products may be determined based on a single previously selected product or two or more previously selected products. For example, a consumer may have previously selected a fish oil product from product display 3. Based on this previously selected product, product display 3 may determine that the consumer is interested in products that reduce the risk of heart disease. In response, product display 3 may suggest vitamin D and CoQ10 products that also are believed to reduce the risk of heart disease.

Upon the determination of one or more suggested options, the options are transmitted to video production unit 8 for the production of an updated video presentation. The updated video presentation includes graphical representations of the options such that the consumer is prompted to select one or more of them. Product display 3 may include input device 13 to allow the consumer to select one or more of the presented options. Input device 13 may be a keyboard, microphone, pointing device, touch sensitive monitor, or any similar device. Upon the selection of an option, video production unit 8 produces a new video presentation based on the selection. For example, upon the consumer selecting an option related to suggested product, a video presentation may be produced that includes educational materials related to the suggested product overlaid on a live video stream of the consumer.

In one embodiment, product display 3 includes product delivery unit 14. Product delivery unit 14 delivers requested/selected products to the consumer. For example, an option presented to the consumer by suggestion unit 12 and video production unit 8 may be for delivery of a suggested product. Upon selection by the consumer of this option, product delivery unit 14 retrieves and delivers the selected product to an easily accessible area of product display 3. Product delivery unit 14 may be a gravity dispenser, a doggy door dispenser, a suction tube dispenser, or similar device.

In one embodiment, product delivery unit 14 delivers coupons for products 3 to the consumer. In this embodiment, product delivery unit 14 may include a printing apparatus for producing customized coupons for consumers. Product delivery unit 14 may deliver coupons in response to the consumer selecting a presented option on primary monitor 16. In another embodiment, product display 3 may include a barcode reader. Upon the consumer scanning a barcode of one of products 3, product delivery unit 14 delivers an associated coupon to the consumer.

In one embodiment, product display 3 includes consumer awareness unit 15 for detecting a consumer/human near product display 3. Consumer awareness unit 15 may receive the video stream from video camera 5 and continually analyzes frames of the video stream to detect the presence of a consumer in the proximity of product display 3. Consumer awareness unit 15 may detect the presence of a consumer using a variety of algorithms and processes including motion detection, facial recognition, feature recognition, or any similar process.

Upon the detection of a consumer, consumer awareness unit 15 sends an activation signal to detecting unit 6. Prior to receipt of the activation signal, detecting unit 6 is in a sleep or waiting state in which processing is deactivated or limited. By selectively activating detecting unit 6 based on the detection of a consumer in close proximity, product display 3 conserves energy and processing power while still ensuring that detection of products 2 occurs without delay.

In one embodiment, consumer awareness unit 15 may also send a signal to video production unit 8 upon the detection of a potential consumer. In this embodiment, video production unit 8 alters the video presentation in response to the signal from consumer awareness unit 15. For example, video production unit 8 may be producing a generalized video presentation that does not specifically address or focus on a particular one of products 2 prior to receipt of the signal from consumer awareness unit 15, but is instead used to attract consumers to product display 3. Additionally, the video presentation at this stage may not include a live video stream. Upon receipt of the signal, video production unit 8 may include the live video stream of the potential consumer along with video and/or audio material that directs the consumer to pick up one of products 2 on display 3. By selectively engaging the potential consumer, product display 3 provides a more personal and sincere advertisement that is directed at a particular consumer.

In one embodiment, consumer awareness unit 15 may determine the attention of a consumer to a presentation on product display 3. For example, a consumer may be determined to be paying a low, medium, or high attention to a presentation. The determination of level of attention may be computed based on the movement of the consumer's eyes, posture of the consumer, detection that the consumer is on a telephone call, etc. This determined level of attention may be transmitted to video production unit 8 to alter the presentation to be more engaging with the consumer. In one embodiment, the determined level of attention is transmitted to video analytics unit 28 for use in the generation of reports as described below.

The video presentation is output by video production unit 8 and played on primary monitor 16. Primary monitor 16 is an output device for presentation of video and images transmitted electronically, for visual reception by the consumer. Primary monitor 16 may use any display technology including a liquid crystal display (LCD), an organic light-emitting diode (OLED) display, a cathode ray tube (CRT) display, or plasma display panel (PDP) display.

In one embodiment, product display 3 includes a context detection unit 17 for determining characteristics of a consumer engaged with the presentation and in the video stream. Context detection unit 17 receives the video stream from video camera 5 and analyzes individual frames or sets of frames to detect characteristics of a consumer interacting with one or more products 2. The detected characteristics may include the age, gender, height, weight, and special needs of the consumer. For example, context detection unit 17 may determine that the consumer is seated in a wheelchair.

Based on the determination, context detection unit 17 outputs the detected characteristics to video production unit 8. Video production unit 8 modifies the video presentation based on the detected characteristics. In one embodiment, in response to context detection unit 17 determining that the consumer is in a wheelchair, video production unit 8 outputs the video presentation to secondary monitor 18 on product display 3. Secondary monitor 18 may be located at a lower level than primary monitor 16 such that it is more easily visible by a consumer in a wheelchair.

In one embodiment, context detection unit 17 outputs the detected characteristics to suggestion unit 12. Suggestion unit 12 may use the detected characteristics of the consumer to determine suggested products for the consumer. For example, the detected characteristics may indicate that the consumer is a male in his eighties and suggest one or more of products 2 intended for older males.

In one embodiment, product display 3 includes video analytics unit 28. Video analytics unit 28 generates reports and statistics related to the interaction of consumers with products 2 over a period of time. Video analytics unit 28 may receive inputs from consumer awareness unit 15, detecting unit 6, and context detection unit 17. Detecting unit 6 may transmit the name or identifier of each product selected by a consumer, context detection unit 17 may transmit the characteristics of the consumer corresponding to each selected product, and consumer awareness unit 15 may transmit the time spent viewing and level of attention of each consumer relative to corresponding presentations. For example, detecting unit 6 may indicate that a consumer picked up 1000 MG capsules of fish oil, context detection unit 17 may indicate that the consumer was a 5′11″ male in his thirties, and consumer awareness unit 15 may indicate that the consumer viewed 2.3 minutes of presentations with moderate attention levels. Video analytics unit 28 may collect and store this information in storage unit 7. At the direction of a user operating product display 3 in a superuser or administrative mode, video analytics unit 28 may generate reports correlating the stored data to produce a set of charts, graphs, tables, and similar materials that may be transmitted ore retrieved by the company responsible for products 2 in display 3. The reports may be broken down or organized by products 2, characteristics of the consumers (e.g. gender and age), date, time, etc. The generated reports assist in detecting trends amongst consumers, determining effective marketing and educational materials, and examining the overall use of product display 3.

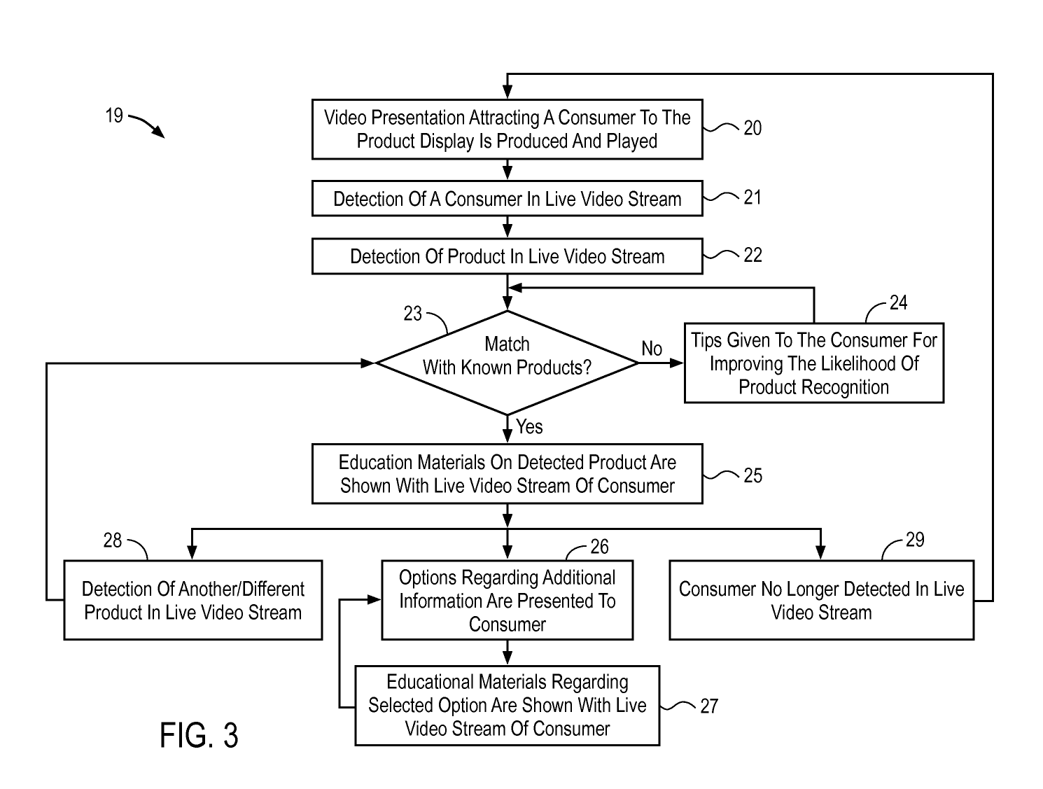

FIG. 3 shows method 19 for advertising one or more products 2 held on product display 3 according to one embodiment. Each of the operations in method 19 may be performed by one or more components shown in FIG. 2.

At operation 20, a video presentation attracting a consumer to product display 3 is produced by video production unit 8 and played on primary monitor 16. The video presentation may include a live video stream of the area in front of product display 3 and attracts consumers to view products 2 on product display 3. In one embodiment, the video presentation includes a virtual pharmacist who waves, smiles, gesture at products, and interacts with consumers as they pass product display 3.

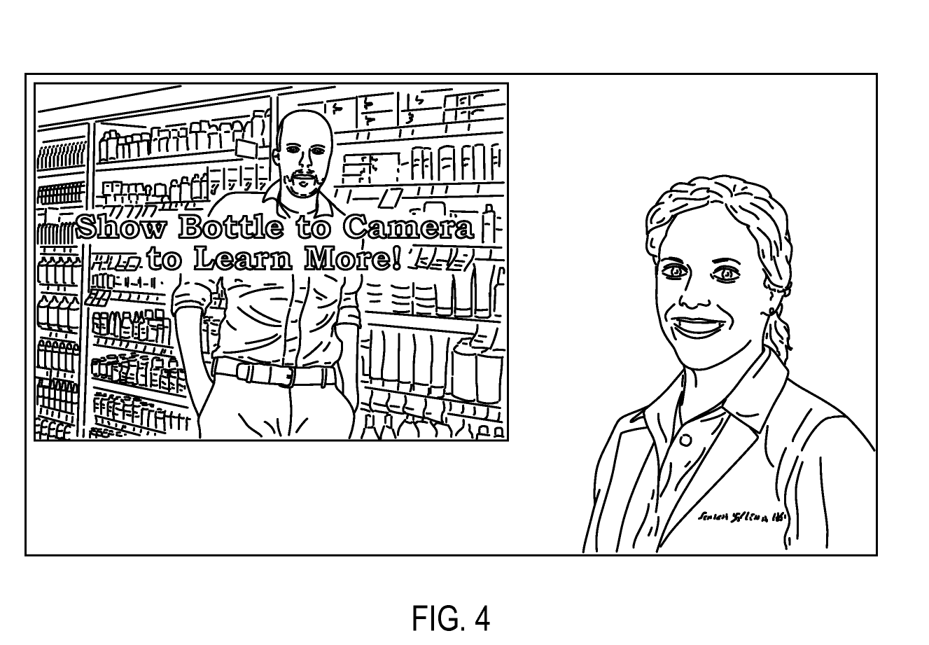

At operation 21, consumer awareness unit 15 detects the presence of a consumer in front of product display 3 and directs the consumer to select and show one of products 2 from product display 3 to video camera 5. FIG. 4 shows a frame of the video presentation generated by video production unit 8 and presented on primary monitor 16 according to operation 21.

At operation 22, detecting unit 6 detects one of products 2 in the video stream and at operation 23 attempts to match the selected product with products 2. If detecting unit 6 cannot recognize the selected product, the video presentation gives tips to the consumer for improving the likelihood of recognition at operation 24. For example, the virtual pharmacist may instruct the consumer to rotate the selected product to better expose label 4 of the selected product to video camera 5.

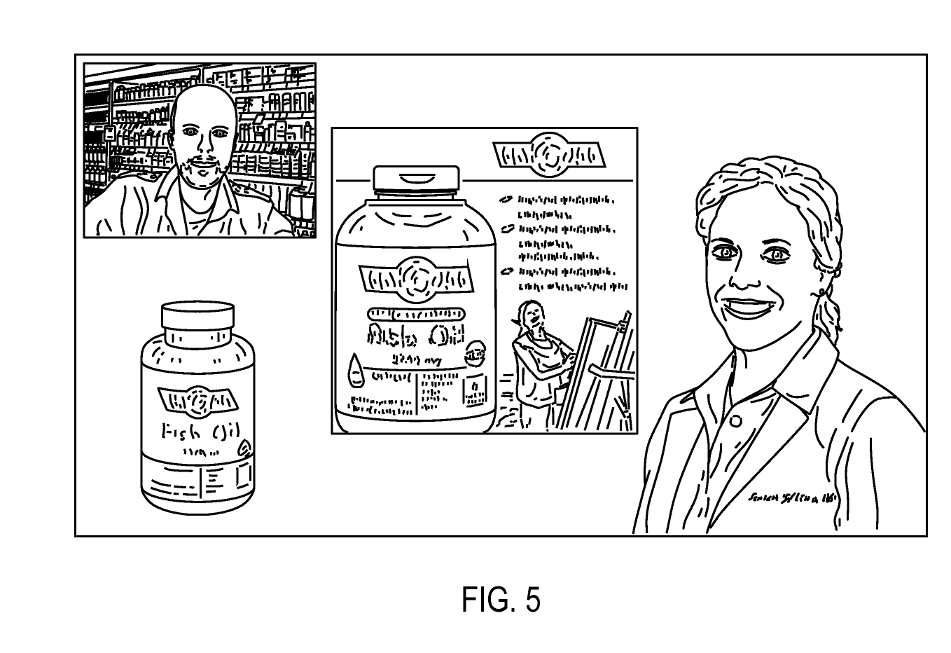

At operation 25, detecting unit 6 has matched/identified the selected product. In response to this detection and identification, the live video stream of the front of product display 3 is minimized to the top left corner of the presentation and educational materials on the selected product are shown in the video presentation. These educational materials include facts and benefits about the selected product shown and explained by the virtual pharmacist in the presentation. FIG. 5 shows a frame of a video presentation generated by video production unit 8 and presented on primary monitor 16 according to operation 25.

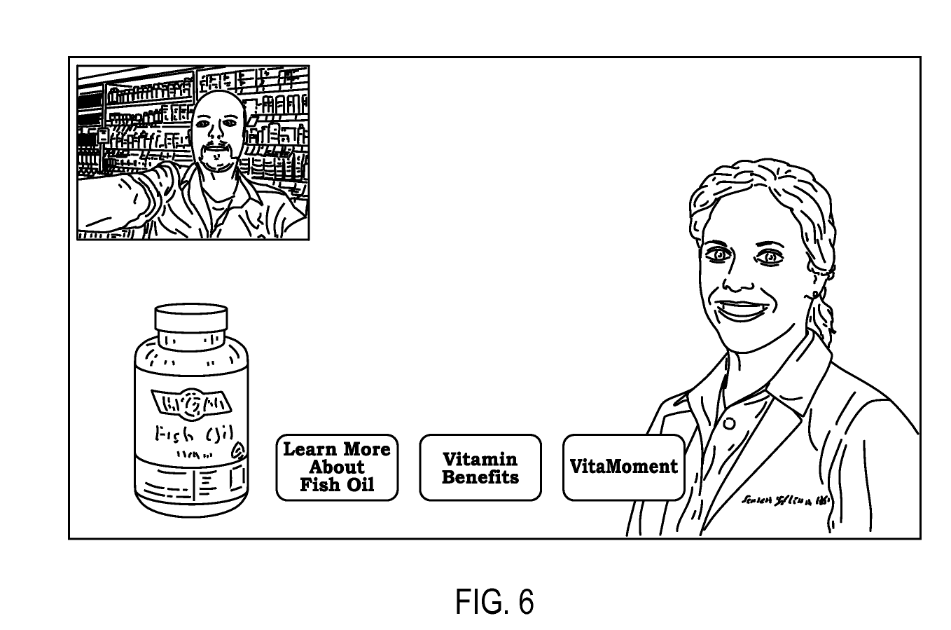

At operation 26, the educational materials have completed and the consumer is presented with options for additional information on selected product. The consumer may select any of the options by touching corresponding buttons on primary monitor 16 or another input device 13. In one embodiment, the options include paging an actual pharmacist in the retail establishment or from an offsite location. For example, an option may be presented to conduct a video conference with a nutritionist at an offsite location. Upon selection of this option, network interface unit 9 establishes a live two-way video conference connection with an offsite nutritionist. Live video of the nutritionist is shown on primary monitor 16 while live video of the consumer may be captured and transmitted by product display 3 to the offsite location. The consumer may ask questions to the nutritionist through input unit 13 (e.g. a microphone) and receive responses through product display 3. FIG. 6 shows a frame of a video presentation generated by video production unit 8 and presented on primary monitor 16 according to operation 26.

At operation 27, the consumer has selected one of the options presented at operation 26 and corresponding educational materials are presented to the consumer. After the presentation of the educational materials, additional options are presented to the consumer at operation 26. This loop continues until the consumer walks away from product display 3 (i.e. out of the video stream) or the consumer holds up a different one of products 2 to video camera 5.

At operation 28, when the consumer holds up a different one of products 2 and the selected product is visible in the live video stream, control of method 19 returns to operation 23, which attempts to match the selected product with products 2 as described above. At operation 29, when the consumer walks away from product display 3 and is no longer visible in the live video stream, control of method 19 moves to operation 20 wherein a video presentation attracting a consumer to product display 3 is produced by video production unit 8 and played on primary monitor 16 as described above.

As explained above, an embodiment may be a machine-readable medium (such as microelectronic memory) having stored thereon instructions, which program one or more data processing components (generically referred to here as a “processor”) to perform the operations described above. In other embodiments, some of these operations might be performed by specific hardware components that contain hardwired logic (e.g., dedicated state machines). Those operations might alternatively be performed by any combination of programmed data processing components and fixed hardwired circuit components.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. The description is thus to be regarded as illustrative instead of limiting.

What is claimed is:

1. A product display, comprising:
a video camera to capture a video in the proximity of the product display;
a detecting unit to detect the presence of a first product from the product display held by a consumer in the video;
a video production unit for combining the video with educational materials on the detected first product to produce an augmented reality presentation; and
a first monitor to display the augmented reality presentation to a consumer.

2. The product display of claim 1, further comprising:
a suggestion unit to generate one or more options to be presented in the presentation following the completion of the educational materials; and
an input device for allowing the consumer to select an option.

3. The product display of claim 1, further comprising:
a consumer awareness unit for detecting the consumer is near the product display based on the video, wherein the detecting unit is activated in response to the consumer awareness unit detecting the consumer is near the product display.

4. The product display of claim 1, further comprising:
a context detection unit to detect special needs and characteristics of the consumer based on the video; and
a second monitor that is activated and displays the augmented reality presentation in response to the context detection unit detecting the special needs of the consumer.

5. The product display of claim 1, further comprising:
a storage unit for storing educational materials associated with products; and
a network interface unit for retrieving additional educational materials from an external server.

6. The product display of claim 1, wherein the detecting unit detects a second product held by the consumer in the video and the suggestion unit determines a suggested product the consumer may be interested in based on the detected first and second products, wherein the video production unit adds education materials about the suggested product to the augmented reality presentation.

7. The product display of claim 4, further comprising:
a video analytics unit to receive an identifier of the detected first product and the detected special needs and characteristics of the consumer and generate a trend report that analyzes consumer actions and interests over time.

8. The product display of claim 5, wherein the network interface unit establishes a live video conference with a remote user and displays the live video conference on the first monitor.

9. The product display of claim 2, further comprising:
a product delivery unit to output products and coupons to the consumer, wherein the options generated by the suggestion unit include options for products and coupons to be delivered through the product delivery unit.

10. A product advertisement system, comprising:
one or more classes of products with high contrast labels; and
a product display, comprising:
a video camera to capture a video in the proximity of the product display;
a detecting unit to detect a high contrast label in the video and associate the high contrast label with one of the one or more classes of products; and
a monitor to display an informative movie about the detected class of product overlaid on a background of the video.

11. The product advertisement system of claim 10, the high contrast labels include a contrast pattern to uniquely identify each of the one or more classes of products.

12. The product advertisement system of claim 11, wherein the detecting unit compares the detected high contrast label to a set of templates in a storage unit to associate the detected high contrast label with the one of the one or more classes of products.

13. The product advertisement system of claim 10, wherein the informative movie continues to play regardless of the position, orientation, or presence of the high contrast label in the video.

14. A method for advertising one or more products, comprising:
receiving a video stream from a video camera integrated in a product display that holds the one or more products;
detecting a consumer holding a first product from the one or more products based on the video stream;
retrieving educational materials related to the detected first product; and
playing a presentation on a screen integrated into the product display, the presentation including the video stream and the educational materials.

15. The method for advertising products of claim 14, further comprising:
presenting an option to the consumer regarding additional educational materials;
retrieving, upon selection of the option, the additional educational materials;
adding the additional educational materials to the foreground of the presentation with the video stream in the background; and
playing the presentation on the screen integrated into the product display.

16. The method for advertising products of claim 14, wherein the detecting the consumer holding the first product comprises:
detecting a high contrast label in the video stream; and
querying a database with an image of the detected high contrast label to identify the first product.

17. The method for advertising products of claim 14, further comprising:
detecting the presence of the consumer in front of the product display based on the video stream, wherein the detecting the first product is performed in response to detecting the presence of the consumer.

18. The method for advertising products of claim 14, further comprising:
detecting the consumer holding a second product of the one or more products based on the video stream; and
suggesting a third product from the one or more products based on the detected first and second products.

19. The method for advertising products of claim 14, further comprising:
detecting characteristics of the consumer based on the video stream; and
adjusting the presentation to address the characteristics of the consumer.

20. An article of manufacture, comprising:
a machine-readable storage medium that stores instructions which, when executed by a processor in a product display,
receive a video stream from a video camera integrated in the product display that stores the one or more products;
detect a consumer holding a first product from the one or more products based on the video stream;
retrieve educational materials related to the detected first product; and
play a presentation on a screen integrated into the product display, the presentation including the video stream and the educational materials.

21. The article of manufacture of claim 20, wherein the processor includes further instructions which, when executed by the processor in the product display,
present an option to the consumer regarding additional educational materials;
retrieve, upon selection of the option, the additional educational materials;
add the additional educational materials to the foreground of the presentation with the video stream in the background; and
play the presentation on the screen integrated into the product display.

22. The article of manufacture of claim 20, wherein the detecting the consumer holding the first product comprises:
detecting a high contrast label in the video stream; and
querying a database with an image of the detected high contrast label to identify the first product.

23. The article of manufacture of claim 21, wherein the processor includes further instructions which, when executed by the processor in the product display,
detect the consumer holding a second product of the one or more products based on the video stream; and
suggest a third product from the one or more products based on the detected first and second products.
